(19) United States
(12) Patent Application Publication
(10) Pub. No.: US 2002/0101874 A1
(43) Pub. Date: Aug. 1, 2002

(54) Physical layer transparent transport information encapsulation methods and systems

(76) Inventors: G. Allan Whittaker, Alpharetta, GA (US); David Smith, Marietta, GA (US); Steve W. Braun, Leucadia, CA (US)

Correspondence Address: JOHN S. PRATT, KILPATRICK STOCKTON LLP (LOCKHEED), 1100 PEACHTREE STREET, SUITE 2800, ATLANTA, GA, 30309, US

(21) Appl. No.: 09/924,037

(22) Filed: Aug. 7, 2001

Related U.S. Application Data
(60) Provisional application No. 60/252,253, filed on Nov. 21, 2000.

(51) Int. Cl. H04L 12/56

(52) U.S. Cl. 370/402; 370/386

(57) ABSTRACT

Systems and methods increase the available bandwidth for stations on a network, eliminate collisions during normal operations, do not require a network administrator, scale essentially linearly, are self-organizing, self-diagnosing and reporting, and are deterministic. One station becomes the starting bus master and creates a table of all the stations on the network along with their corresponding delays relative to the starting bus master. The stations communicate in an order determined by the starting bus master with the first station being a starting bus master and the last station an ending bus master. The starting bus master transmits a beginning of sequence message and the ending bus master generates an end of sequence message. The stations need not be limited to any specific wavelength nor need they be forced to transmit during any specific time slot. The network automatically adds or drops stations from the network.

### RELATED APPLICATIONS

This application claims priority to, and incorporates by reference, co-pending provisional application Serial No. 60/252,253 entitled “Systems and Methods Employing an Optical Network Transport Protocol,” filed on Nov. 21, 2000.

### FIELD OF THE INVENTION

The invention relates to systems and methods for communicating over a bus and, more particularly, to systems and methods for communicating over an optical bus.

### BACKGROUND

Any communications network, regardless of whether it includes a fiber, wireline, or wireless bus, requires some type of protocol or methodology to allow members to communicate with each other. Without any type of protocol, two or more members may try to use the bus at the same time, thereby interfering with each other and preventing any of them from passing their messages. Thus, protocols at a minimum need to address how and when members can communicate over the bus, how members identify each other, and the general form of the messages.

One approach taken by many protocols is to effectively divide the total bandwidth by the number of members. Some networks are time-division-multiplexing (TDM) networks and allocate given time slots to the various members. Other networks are wavelength-division-multiplexing (WDM) networks and allocate certain bandwidths to the members. Still other networks operate as a combination of TDM and WDM are accordingly allocate to the members given time slots at certain defined wavelengths. A difficulty with apportioning bandwidth by the number of members is that as the network grows in the number of members, the amount of bandwidth is proportionately reduced. The desire to increase network size is therefore countered by the decrease in available bandwidth.

Because of a desire to allocate bandwidth and to identify nodes on a network, networks typically have some administrator whose sole job is to oversee operation of the network. The administrator may oversee the physical components of the network, such as the network medium, network cards, the nodes, as well as any hubs, routers, repeaters, switches, or bridges. Additionally, the administrator manages the addition or deletion of nodes from the network and the accompanying change in addressing. The administrator also performs maintenance, upgrades, and other periodic work on the network. The administration of a network can therefore be rather costly to an organization.

FIG. 1 reveals problems associated with operating many conventional networks. As depicted in this figure, the cost of the materials themselves, such as the hardware in a network, has rather steadily decreased with time and has become substantially less expensive than the costs 10 years ago. In contrast, the labor costs for administering a network have surpassed the materials costs and have continued to rise. The number of installations used in FIG. 1 were derived from an Apr. 3, 2001 study conducted for the American registry for Internet Numbers, Chantilly, VA and the cost per installation was derived from a study by Cisco Systems, Inc.

One of the most common network protocols is the Ethernet, which is defined by IEEE Standard 802.3, which is incorporated herein by reference. Ethernet has evolved over the years and can be placed on different media. For example, thickwire can be used with 10Base5 networks, thin coax for 10Base2 networks, unshielded twisted pair for 10Base-T networks, and fiber optic for 10Base-FL, 100Base-FL, 1,000Base-FL, and 10,000Base-FL networks. The medium in part determines the maximum speed of the network, with a level 5 unshielded twisted pair supporting rates of up to 100 Mbps. Ethernet also supports different network topologies, including bus, star, point-to-point, and switched point-to-point configurations. The bus topology consists of nodes connected in series along a bus and can support 10Base5 or 10Base2 while a star or mixed star/bus topology can support 10Base-T, 10Base-FL, 100Base-FL, 1,000Base-FL, and Fast Ethernet.

Ethernet, as well as many other types of networks, is a shared medium and has rules for defining when nodes can send messages. With Ethernet, a node listens on the bus and, if it does not detect any message for a period of time, assumes that the bus is free and transmits its message. A major concern with Ethernet is ensuring that the message sent from any node is successfully received by the other nodes and does not collide with a message sent from another node. Each node must therefore listen on the bus for a collision between the message it sent and a message sent from another node and must be able to detect and recover from any such collision. A collision between message occurs rather frequently since two or more nodes may believe that the bus is free and begin transmitting. Collisions become more prevalent when the network has too many nodes contending for the bus and can dramatically slow the performance of the network. To allow nodes to detect a collision, the size of the message itself is set large enough so that a node transmitting a message can detect a jamming signal from a node at the farthest point in the network and thus detect the collision. As the speed of the network increases, the size of the minimum message increases. For instance, for a 5 km bus diameter, at 10 Mbps the minimum message size is 512 bits, at 100 Mbps the minimum message size is 5,120 bits at 1 Gbps the minimum message size is 51,200 bits, and at 10 Gbps the minimum message size is 512,000 bits. An unfortunate down side to this minimum message size is that each node always has to transmit messages at least of this minimum size even for small amounts of data. Many of the messages on the network physical layer therefore include filler or empty spaces, which is a waste of valuable bandwidth.

As mentioned above in connection with Ethernet, networks can operate at various speeds. Ethernet, for example, has evolved from 10Base2, 10Base5, and 10Base-T, 100Base-T and is now reaching 10 Gbps. These fast speeds, however, might be deceiving to the actual end user sitting at a workstation forming one of the nodes. The designation of speed with Ethernet refers to the speed of the backbone. The user's workstation would not be connected to the backbone but instead would connected to other nodes on a switch or hub, which may be connected to other hubs through a switch, which may be interconnected to the backbone through bridges. The actual effective bandwidth on the backbone available to the user's workstation can be significantly less than that designated for the backbone. Thus, while speeds may be increasing for the backbone, the network performance from the perspective of the user's workstation may be terribly deficient and slow.

As an example of an Ethernet system, FIG. 2 shows a network 10 having stations 12 connected to an optical bus 14. Each of these stations 12 is connected to the bus 14 through a coupler 16. As mentioned above, the Ethernet protocols are designed to include collisions between stations trying to capture the bus. FIG. 3 provides an explanation as to how such a network 10 can recover from a collision. At 22, both stations A and B 12 are ready to transmit and listen on the bus for a clear line, such as for a 96 bit time period. At 23, at the end of this 96 bit delay period, both stations A and B 12 determine that the line is clear and begin transmitting while simultaneously listening. At 24, the signal from the A station 12 reaches the B station 12, at which point the A station 12 detects a collision. At 25, the A station 12 transmits a jamming signal to ensure that the B station 12 sees the collision before the A station 12 finishes its message. At 26, the B station 12 detects the signal from the A station 12 and responds by sending a minimal length jamming signal. Both the A station 12 and the B station 12 then enter a back-off protocol, during which the stations 12 wait a period of time before attempting to communicate again over the bus 14. As should be apparent from FIG. 3, the entire time that the stations 12 are listening on the bus 14, transmitting their signals, transmitting jamming signals, and then the delays during the back-off protocol are all times that the bus 14 is under-utilized.

FIG. 4 further illustrates the inefficiencies associated with the Ethernet protocols. FIG. 4 is a timing diagram between four different stations, each represented in the diagram by a horizontal timing diagram. At 31, a message is sent from a B station and, as shown in the other diagrams, is received at the other stations A, C, and D after different periods of delay. A message is therefore successfully transmitted from the B station at 31. At 32, the A station begins to transmit and then a short period of time later the C station begins to transmit. At 33, the transmissions between these two stations A and C create a collision which results in the stations entering the back-off protocol. This back-off protocol is not always successful, as shown at 34 where a second collision occurs between stations A and C. After a second back-off protocol and associated delays, the C station is finally able to send a message successfully to stations A, B, and D. Also at 34, the A station then follows with its transmission of data to the B, C, and D stations. As can be appreciated by those skilled in the art, the occurrence of these collisions becomes more prevalent with more stations on the bus which can substantially reduce the through-put of the bus.

Technical Report CSRI-298, entitled “A New Binary Logarithmic Arbitration Method for Ethernet,” by Mart L. Moelle of Computer Systems Research Institute, Apr. 1994 provides some examples of Ethernet performance under overload conditions which are reproduced as FIGS. 5(A) to 5(F). FIG. 5(A) is a graph of Ethernet utilization in MBits/sec. versus the number of hosts for different packet sizes, FIG. 5(C) is a graph of Ethernet utilization in packets/sec., and FIG. 5(E) is a graph of average transmission delay in milliseconds. As is apparent from these graphs, as more hosts are added to an Ethernet network, the Ethernet utilization in terms of both MBits/sec. and packets/sec. drop off and the average transmission delay increases. While the Ethernet utilization in MBits/sec. increases with larger packet sizes, this advantage in speed is traded off with decreases in utilization in packets/sec. and longer average transmission delays.

FIG. 6 illustrates an approach taken to improve the through-put and performance of a network. The network 40 shown in FIG. 6 includes a backbone 41 and a number of spoke networks 44 connected to the backbone 41 with switches or hubs 42. The backbone 41 is able to operate at higher speeds than the spoke networks 44. Each spoke network 44 interconnects a number of stations 45, such as the spoke network 44 of stations A, B, C, and D. The high speed rating of the main backbone bus 41 is perhaps misleading since the actual bandwidth between any pair of stations 45 is limited to the performance of the switched or hub networks 44. Thus, despite the high speed ratings of many Ethernet networks, the actual bandwidth available at a single station is significantly less than this rating of the network backbone 41.

### SUMMARY

The invention addresses the problems above by providing systems and methods for communicating over a network. According to a preferred embodiment, a network comprises an arbitrary number of stations operating in one of three modes. There may be two dynamically distributed bus masters located at either end of a bus; all other stations operate in normal mode. One of the bus masters determines an order in which the stations have authority to transmit with this order preferably determined according to the locations of the stations along the bus. Once the order is determined, the one bus master sends the order to all of the stations. The first station to transmit, which is preferably a starting bus master, initiates a message sequence with a beginning of sequence message and then the stations inserts their message in the proper order. An ending bus master which is the last station to transmit preferably sends an end of sequence message. After the last station has inserted its data and the end of sequence message, the starting bus master begins the transmission of the next message sequence by transmitting another beginning of sequence message.

Networks according to preferred embodiments of the invention have many advantages, including that they are self organizing, do not require a network administrator, scale essentially linearly, and significantly increase the throughput available to each user or station on the network physical layer. The methods according to the invention can be used in a number of different networks and network topologies.

The network is self-organizing and does not require a network administrator in that it can respond to, and recover from, any condition, such as a warm start of one or more nodes, a kill state, abort state, or a test state. In the preferred embodiment, two of the stations on the network are appointed starting and ending bus masters. Based on relative propagation time delays for each station, the starting bus master (SBM) builds a table of all stations on the network physical layer and their network address assignment. The SBM pings each station, measures the delay time from when a response is received back from each station, and builds the table with these delay times. The station farthest away is designated the ending bus master (EBM). Its responsibility is to transmit an End of Sequence (EOS) message. When a new station enters the network physical layer, such as during a warm start, the new station interjects a message after the EOS message and the SBM responds appropriately by addressing the new station, measuring the delay time for a response, adding the station to the table, and possibly even passing the starting or ending bus master responsibilities to the new station. The starting and ending bus masters are preferably assigned to the stations at each end of the network physical layer so as to optimize performance of the network.

The network physical layer does not require that all messages conform with some minimum message length. The messages include a header, any information or data, and a trailer. The information itself can be of any size, from an empty set to a maximum limit, such as one imposed by physical constraints in the interfaces. Therefore, a station can, in theory according to the invention, transmit as long as desired and release the bus only when everything has been transmitted. Practically, some maximum message length is preferably set so as to provide for more optimal use of the network physical layer by all stations. The networks do not require some minimum message length dictated for collision detection purposes. Instead, the networks allow nodes to transmit a synch message that, in effect, says that the station has nothing to send. The networks therefore make additional bandwidth available for more efficient use by all stations in the network.

As mentioned above, the stations transmit a synch message when the stations do not have any information or data to transmit. The transmission of a synch message provides a number of advantages. For example, the synch message keeps optical and electrical phase lock loops “locked.” Also, the synch message informs all stations that the station is functioning properly even though it does not have a data message to send. Because each stations transmits some type of message, such as a synch message, the health of each station can be easily monitored as well as dynamic testing of the physical layer while it operates. In contrast, Fibre Channel and other such networks must be taken off-line to test the physical layer. In addition to these advantages, the use of a synch message informs the next station in the order to transmit.

Other advantages and features of the invention will be apparent from the description below, and from the accompanying papers forming this application.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1 is a graph illustrating trends in labor costs and material costs over a ten year period for conventional networks;

FIG. 2 is a block diagram of a conventional network of two stations connected to a common bus;

FIG. 3 is a timing diagram explaining how a collision occurs between the two stations in FIG. 2;

FIG. 4 is a simulated message cycle of four stations transmitting messages on the bus and shows two collisions;

FIGS. 5(A) to 5(F) are graphs depicting performance of an Ethernet network;

FIG. 6 is a conventional network diagram having a main backbone and hubs;

FIG. 7 is a flow chart of a method according to a preferred embodiment of the invention;

FIG. 8 is an example of a message sequence according to the preferred embodiment of the invention;

FIG. 9 is a block diagram of two stations connected to a dual redundant common bus using the methods according to the invention;

FIGS. 10(A) and 10(B) are block diagrams and associated timing diagrams illustrating transmissions between stations in a two station network and three station network, respectively;

FIG. 11 is a state transition diagram for stations on the bus;

FIG. 12 is a state level diagram for stations on the bus;

FIG. 13 is a bit-level diagram illustrating preferred fields in a message;

FIG. 14 is a state transition diagram for a normal message send process;

FIG. 15 is a state transition diagram for a normal message listen process;

FIG. 16 is a simulated message cycle of four stations using the methods according to the invention;

FIG. 17 is an exemplary network having stations spaced along a bus;

FIG. 18 is a simulated message cycle showing a warm start;

FIG. 19 is a state transition diagram for a measurement mode;

FIG. 20 is a state transition diagram for a normal starting bus master mode;

FIG. 21 is a state transition diagram for a normal mode; and

FIG. 22 is a state transition diagram for a normal ending bus master mode.

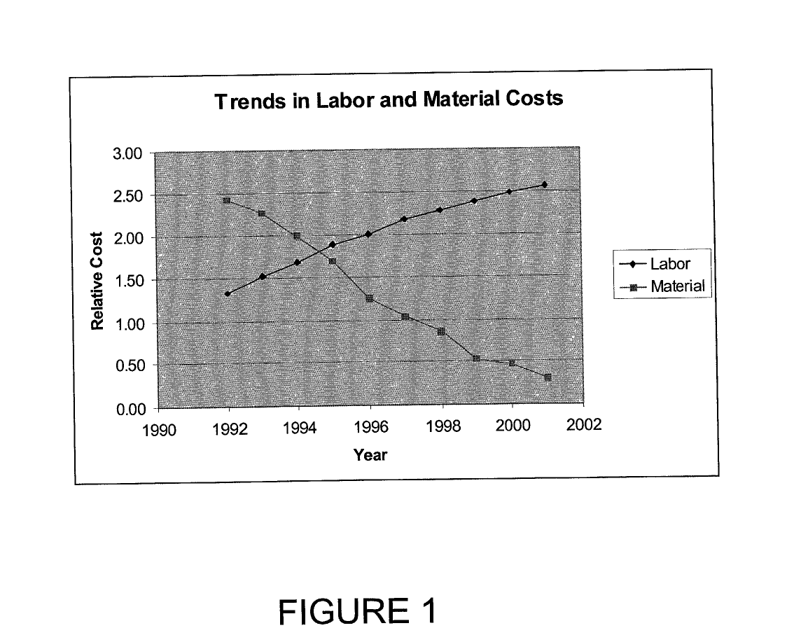

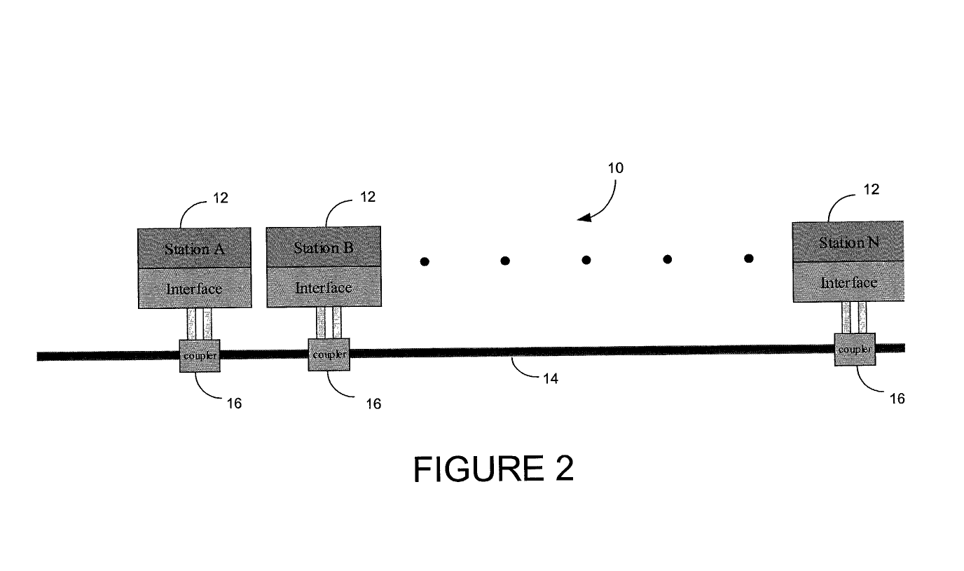

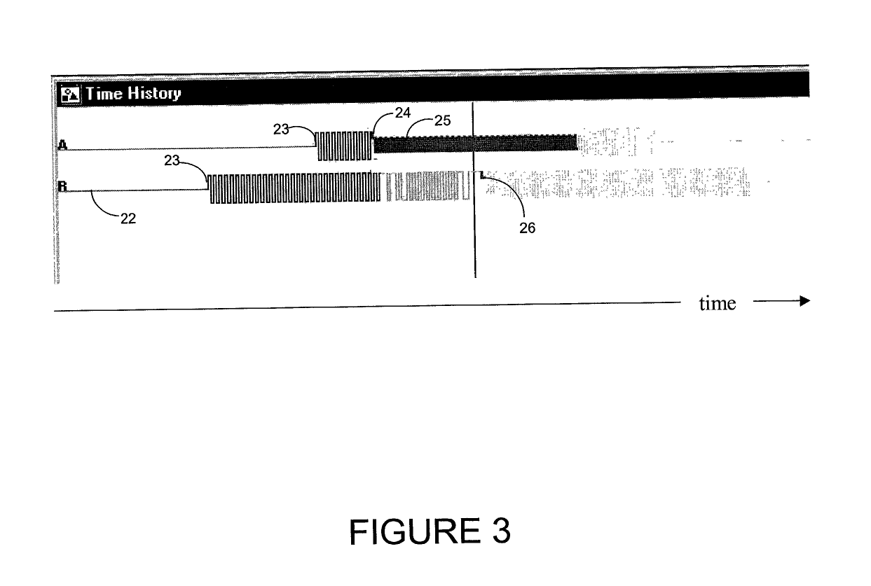

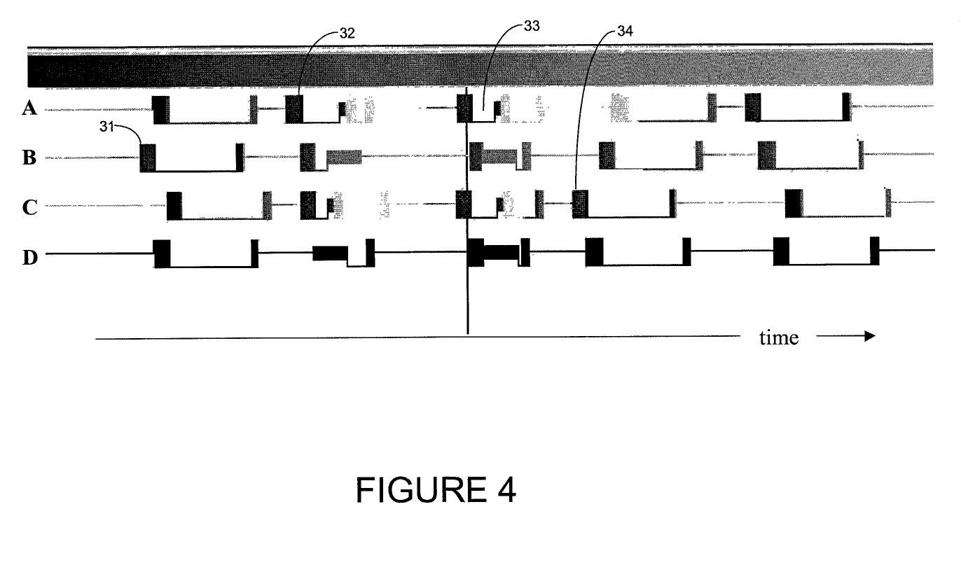

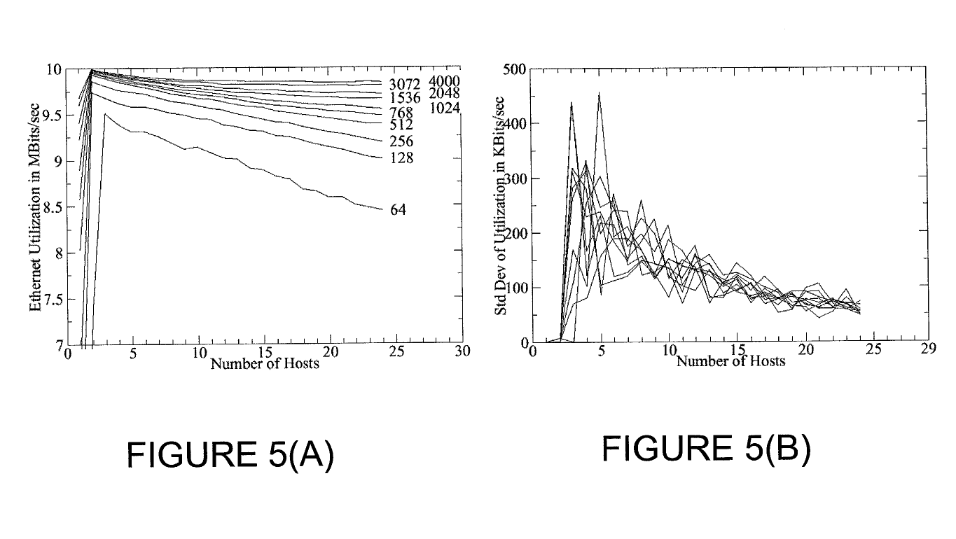

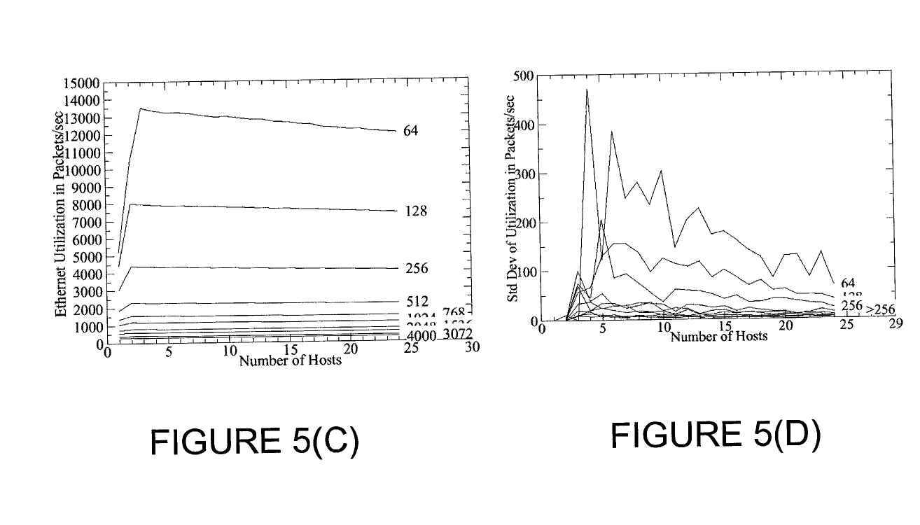

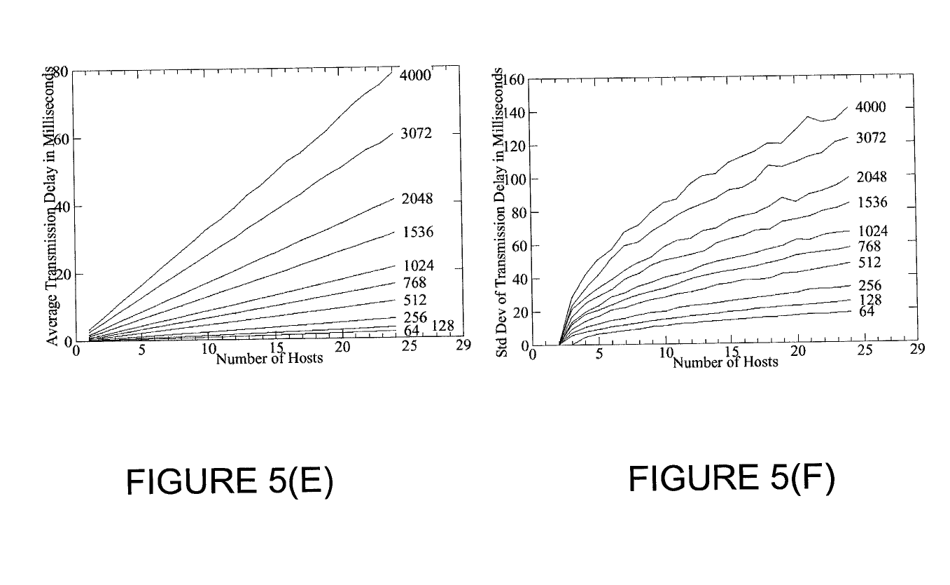

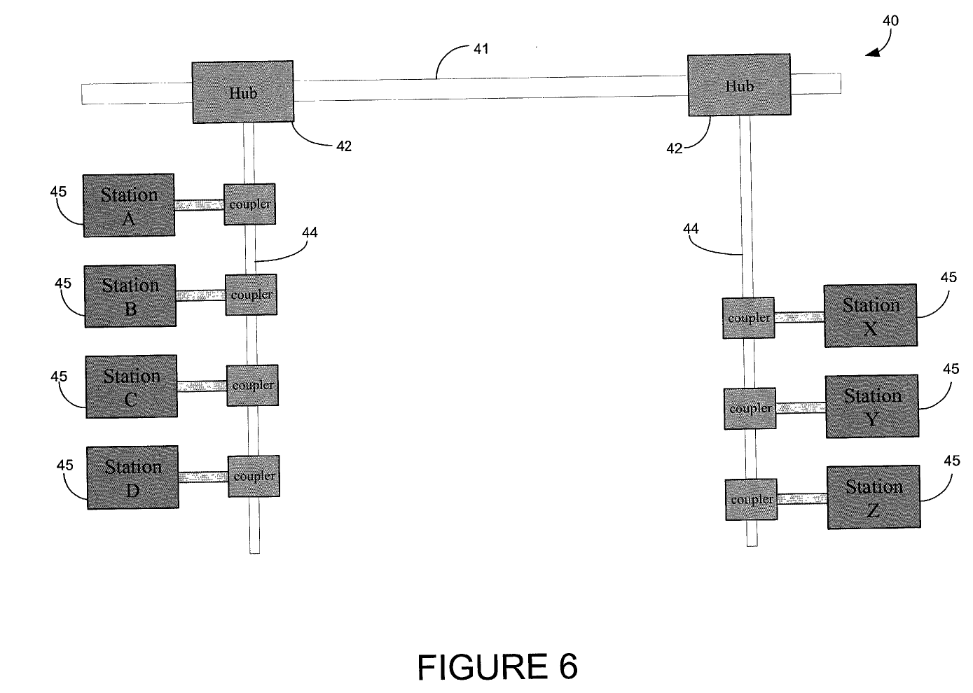

### DETAILED DESCRIPTION

Reference will now be made in detail to preferred embodiments of the invention, non-limiting examples of which are illustrated in the accompanying drawings.

I. Overview

Systems, methods, and networks according to the preferred embodiments of the invention have that many advantages over existing systems, methods, and networks. During normal operation, a network has bus master responsibilities distributed between two stations called a starting bus master (SBM) and an ending bus master (EBM) which are preferably located at either end of a bus. The SBM creates a table of all stations on the network physical layer and determines an order by which the stations communicate and informs each of these stations of all of the relative station positions within the order. The SBM, which is preferably the first station in the order, begins a message sequence with a beginning of sequence (BOS) message and then each station, including the SBM, transmits their messages in the proper order. The EBM, which is preferably the last station in the order, transmits its message and transmits an end of sequence message (EOS) message indicating the end of the message sequence. The process then repeats with the next message sequence being introduced by the BOS message and ending with the EOS message.

When the stations are added to, or dropped from, the network, the SBM makes appropriate adjustments to the order in which the stations transmit. The SBM preferably also coordinates the proper addressing of messages between the stations. Preferably, the stations in the network are not tied to any minimum message length and in theory can transmit as much or as little data as desired.

The methods according to the invention can be used on a variety of different networks and is preferably implemented on a bi-directional bus. With a bi-directional bus, the messages from each station are routed in both directions over the bus so that each message can be received at every station. As mentioned above, the order in which stations have the authority to transmit preferably progresses in one direction along the bus. This single direction in which the order of transmission moves, however, should not be confused with the bi-directional nature in which the messages travel along the bus.

The systems and methods according to the invention offer a number of advantages over conventional systems and methods. These advantages and others will become more apparent from the description below. Some of these advantages include, but are not limited to, the abilities of the networks, systems, and methods to be self-organizing, to avoid collisions during normal operation, to be self-diagnosing in reorganizing, to offer self-performance reporting, to operate over dynamic working network diameters, to provide variable message lengths, to be deterministic, and to perform multicast.

II. Operation

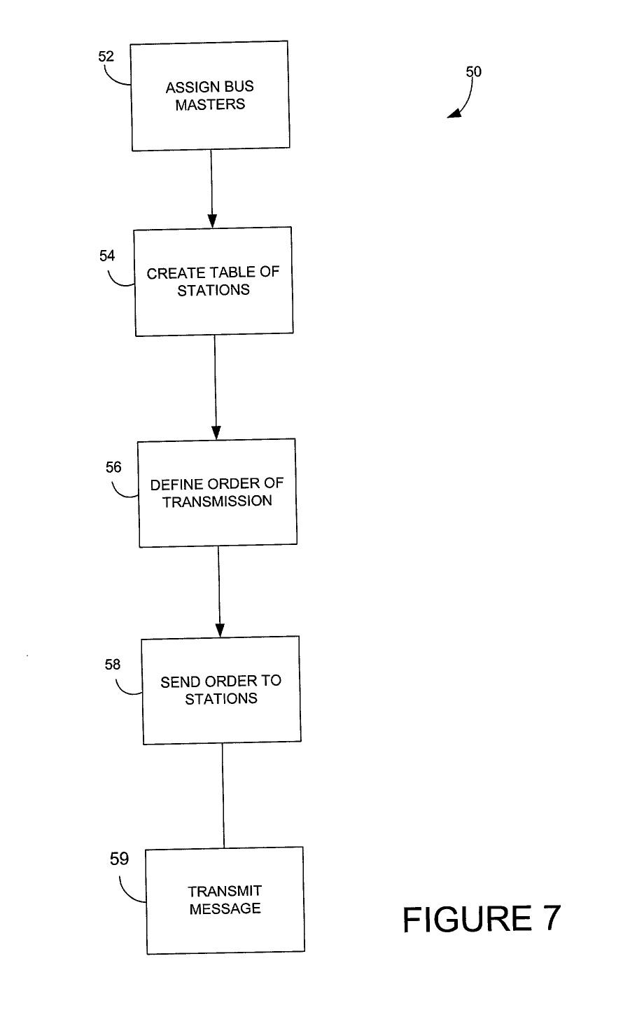

A method 50 according to a preferred embodiment of the invention will now be described with reference to FIG. 7. At 52, one of the stations on the network physical layer is assigned the SBM. One of the duties performed by the SBM is determining an order of transmission for the stations, which is preferably performed by creating or maintaining a table of stations on the network at 54. As described in more detail below, the SBM creates this table by sending a query to each station and measuring the time it takes to receive a response back from each station. The SBM places these delay times in the table and, based on the delay times, defines the order of transmission for the stations. This order of transmission is then sent to all of the stations at 58 and at 59, the rest of the message is sent by the SBM followed by messages from subsequent stations. A message, or synch, is sent immediately following the authority to transmit table. Thus the table transmission is a normal operation as seen by the EBM.

The SBM initiates a message sequence with a beginning of sequence (BOS) message which may include its own data to transmit. The SBM is preferably the first station to transmit within the order of stations. The EBM is preferably the last station to transmit and, after it transmits its own message, transmits the EOS message. During operation of a network, stations may switch between the different bus master types and between bus master and normal states. For example, the first station along the bus from the failed SBM could preferably automatically become the SBM if the original SBM fails.

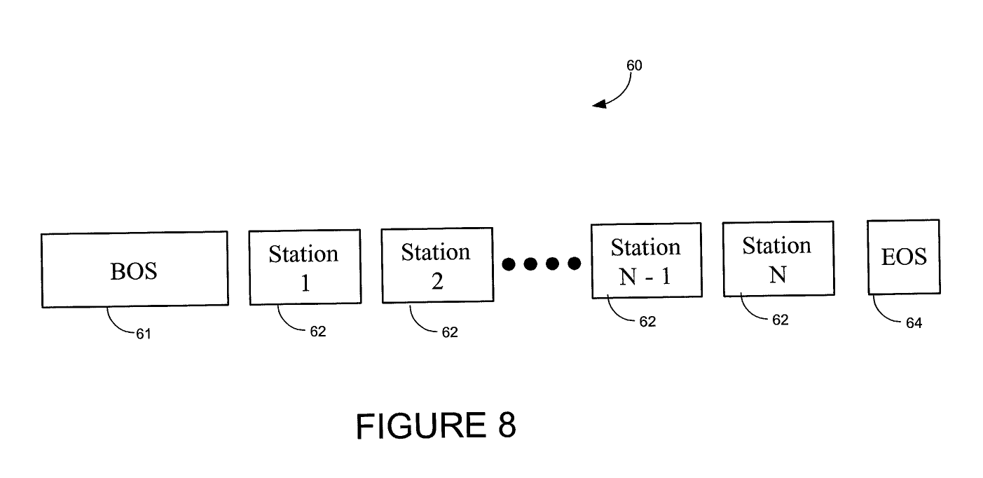

An exemplary message sequence 60 is shown in FIG. 8. The typical message sequence 60 includes the BOS message 61 followed by messages 62 from each of the stations 1 to N. Although the BOS message 61 can be separate from the message from the SBM, the BOS message 61 and the message from the SBM are preferably combined to improve utilization of the network. After each station has transmitted its message, the EBM transmits the EOS message 64 symbolizing the end of a message sequence 60. In operation, each station waits for the end of a transmission from the station immediately preceding it in the order of transmission. Once a station sees this message from its predecessor, the station can then insert its own message 61 into the message sequence 60. While the messages from each of the stations 1 to N are represented with equal lengths, as will be appreciated from the description below, each station can transmit messages of varying lengths, from a synch message indicating that no message is being transmitted to the maximum message length, if one is imposed by the network designer. Each station preferably transmits at least some message, such as a synch message, even if it does not have any data to transmit in order to inform the next station in the order that it can transmit its message. When a station detects the EOS message 62, the station can assume that its message was successfully transmitted. In contrast to Ethernet, the messages 61 need not contain extraneous bits which are added to ensure successful delivery of the message.

As mentioned above, the method 50 and message sequence 60 can be embodied in a number of different systems or networks. A preferred network topology is shown and described in U.S. Pat. Nos. 5,898,801 and 5,901,260, the contents of which are incorporated herein by reference. Other examples of networks include, but are not limited to, those described in U.S. Pat. Nos. 4,166,946 to Chown et al., 4,249,266 to Nakamori, 5,369,516 to Uchida and in U.K. Patent Application 2,102,232 A to Chown et al. As additional examples, the systems and methods according to the invention can be implemented in point-to-point, star coupled, ring, or token ring networks.

The invention can also be implemented over any communication media. In the preferred embodiment, the communication media carry optical signals and may comprise, but are not limited to, single mode optical fibers, multi-mode fibers, twisted pair copper, coaxial cables, waveguides, free space, and water. Also, while the invention will be described with reference to optical signals, the systems and methods of the invention can also be implemented with electrical signals and radio frequency (RF) signals. With optical communication systems, the stations are preferably coupled to the optical fiber with a passive coupler, such as those described in U.S. Pat. Nos. 5,898,801 entitled “Optical Transport System” and U.S. Pat. No. 5,901,260 entitled “Optical Interface Device,” which are incorporated herein by reference. Each station connected to the optical bus has an optical receiver, an optical transmitter, or preferably both an optical receiver and transmitter. The precise type of coupler to the optical bus will vary with the type of equipment at the station. For instance, the coupler may include tunable filters, wavelength division multiplexers, taps, circulators, or other devices for coupling or routing optical signals to and from the station.

The invention is not limited to the type of equipment at the station and some examples of common equipment include computers, sensors, work stations, cameras, displays, input devices, controllers, networks of such equipment, and other data or communication devices. The invention is also not limited to the type of signals carried by the bus with some examples including analog, digitized analog, digital, discrete, radio frequency, video, audio signals, and other data signals. The invention is not limited to the type of optical transmitter but includes LEDs and lasers, both externally and directly modulated. As will be appreciated by those skilled in the art, each station may also include translation logic devices and other devices used in the processing or routing of the signals. A preferred network is described in U.S. Pat. No. 5,898,801 entitled “Optical Transport System,” which is incorporated herein by reference.

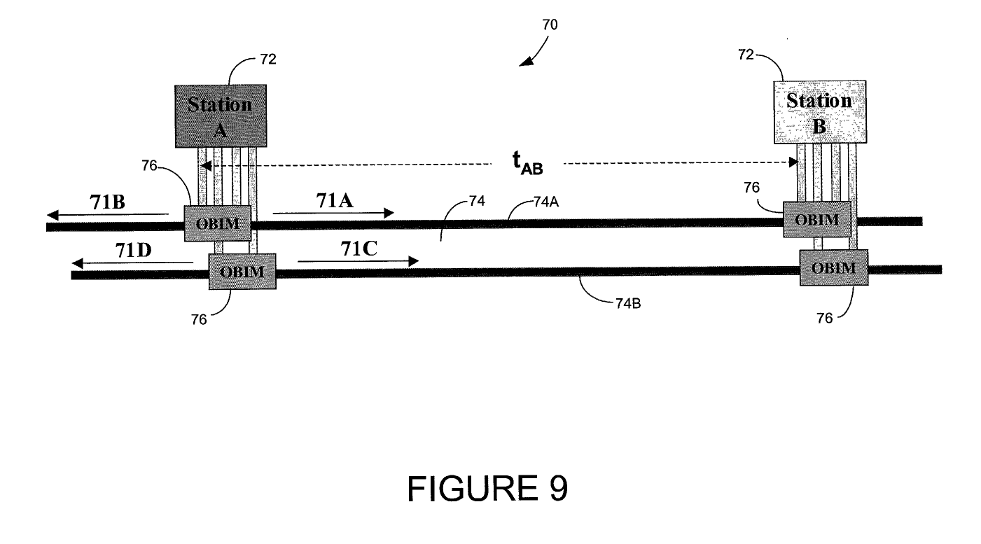

FIG. 9 illustrates an example of a network 70 according to the preferred embodiment of the invention. The network 70 includes a plurality of stations 72 A and B connected to a bus 74 through couplers 76. The bus 74 actually includes a plurality of busses, illustrated here with two busses 74A and 74B with bus 74A being a primary bus and bus 74B being a redundant back-up bus. The couplers 76 route signals from each station 72 in both directions along each of the busses 74A and 74B. A single signal therefore is split into four components and routed in four directions 71A, 71B, 71C, and 71D. As represented in this diagram, a message sequence 71A travels along bus 74A in a direction from the A station 72 to the B station 72, a message sequence 71B travels along bus 74A in an opposite direction away from the B station 72, a message sequence 71 C travels along bus 74B in a direction from the A station 72 to the B station 72, and a message sequence 71 D travels along the bus 74B in an opposite direction away from the B station 72. While not shown in the Figure, signals from the B station, as well as all other stations, are split into separate components and routed in opposite directions on the busses 74A and 74B. The messages may be of variable length whereby each station need not transmit the same size message nor need they pad their message with extra bits. The A station 72 waits until the preceding station terminates its transmission before adding its message to the message sequence 71.

The stations 72 can also operate under any media access, network, transport, session, presentation, or application protocol. These protocols include, but are not limited to, the Ethernet standard, as specified by International Standards Organization (ISO) 802.3, Mil_Std 1553, ARINC_{—}429, RS-232, RS-170, RS-422, NTSC, PAL, SECAM, AMPS, PCS, TCP/IP, frame relay, ATM, fiber channel, SONET, WAP, and InfiniBand.

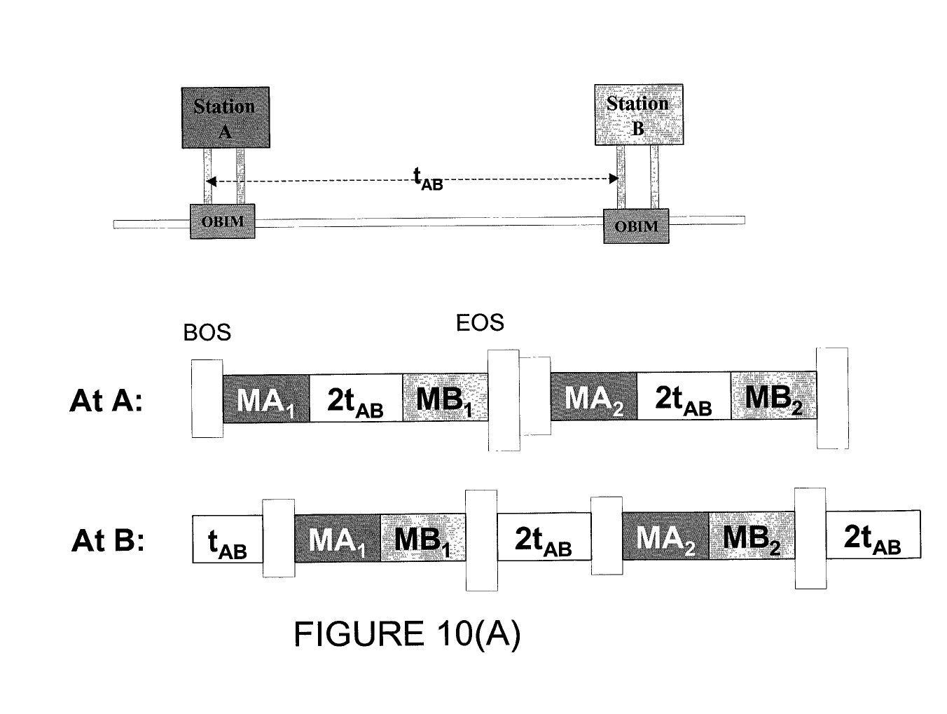

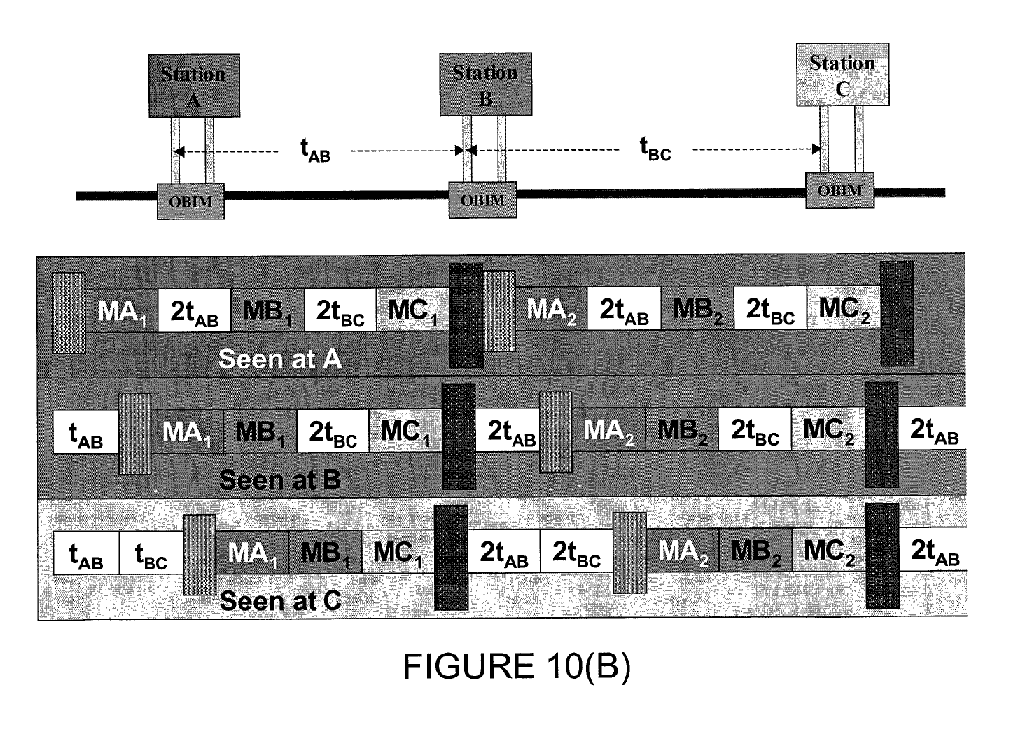

FIGS. 10(A) and 10(B) provide further examples of stations transmitting on a bus and also illustrate representative timing diagrams. FIG.10(A) illustrates a two station network and shows the timing diagram from the A station perspective and also from the B station perspective. As shown in these timing diagrams, the perspectives from the two stations differ. For example, with the A station, a delay period of 2t_{AB} appears after the A station transmits MA₁ and before the A station receives a transmission of MB₁ from the B station. In contrast, the delay period of 2t_{AB} appears right after the B station transmits MB₁ and before the B station receives MA₂. FIG. 10(B) shows a network with three stations, stations A, B, and C, and their associated timing diagrams. Again, as with the timing diagrams shown in FIG. 10(A), the timing perspective of the network depends on the viewpoint of the particular station.

One advantage of the networks according to the invention is that they are highly deterministic. A difficulty with other protocols, especially switched networks and Ethernet, and multicast or broadcast, is that it is hard, if not impossible, to determine exactly how a network will operate at a given moment over a period of time, or even to determine prior performance of the network. A primary reason for this unpredictability is that unplanned collisions between stations occur, thereby forcing stations into a randomly generated back-off waiting period and possibly subsequent collisions. For hierarchical switched networks, such as LANs and the Internet, it is not possible to determine how the network will operate as the packet routings through the switches cannot be predicted a priori. In addition, it is statistically possible for packets to arrive out of sequence or not at all. Prior network performance, for a sample interval, could be deduced by measuring the hierarchical network during its operation but the prior performance is a poor indicator of future performance.

A number of state transition diagrams will be used to describe the operation of the methods according to the preferred embodiment of the invention. These state transition diagrams illustrate how the transport mechanism itself, as well as the status at each station, is highly deterministic.

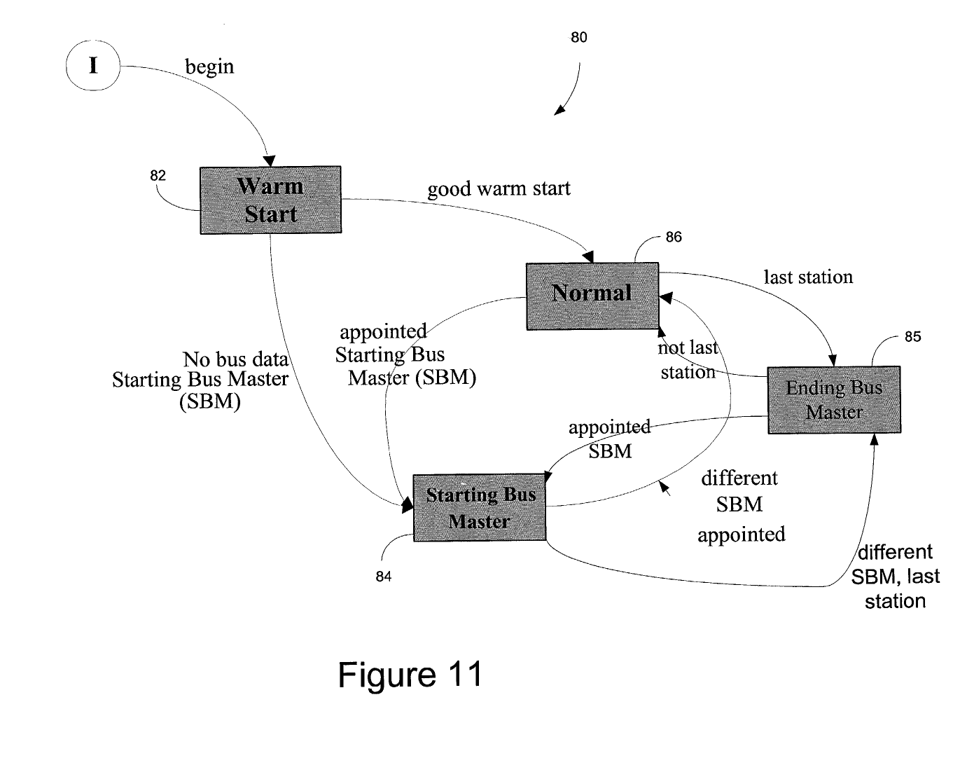

A state transition diagram 80 for stations is shown in FIG. 11. A station begins with a warm start at 82 and then either proceeds to an SBM state 84 as the SBM if no bus data is detected or to a normal state 86. The warm start process 82 will be described in more detail below with reference to adding or removing nodes from the network physical layer. As mentioned above, the SBM state 84 occurs when a station appoints itself as the SBM. The SBM state at 84 also occurs when the station is appointed as the SBM by another station. If the station is not operating as the SBM, then the station operates in normal mode and proceeds to the normal state at 86. However, if the station is the last station, then the station becomes the EBM at 85 and has the responsibility of generating the EOS message. As shown in FIG. 11, a station can operate in a normal state at 86, can be appointed the SBM and proceed to the SBM state at 84, or can become the EMB and proceed to the EBM state at 85. As another option, a station may be in the SBM state at 84 and proceed to the normal state at 86 if a different SBM is appointed or proceed to the EBM state at 85 if a new station is the SBM and that station is the last station. From the EBM state 85, a station can transition to the normal state at 86 is it no longer remains the last station or can proceed to the SBM state at 84 if it is appointed the SBM.

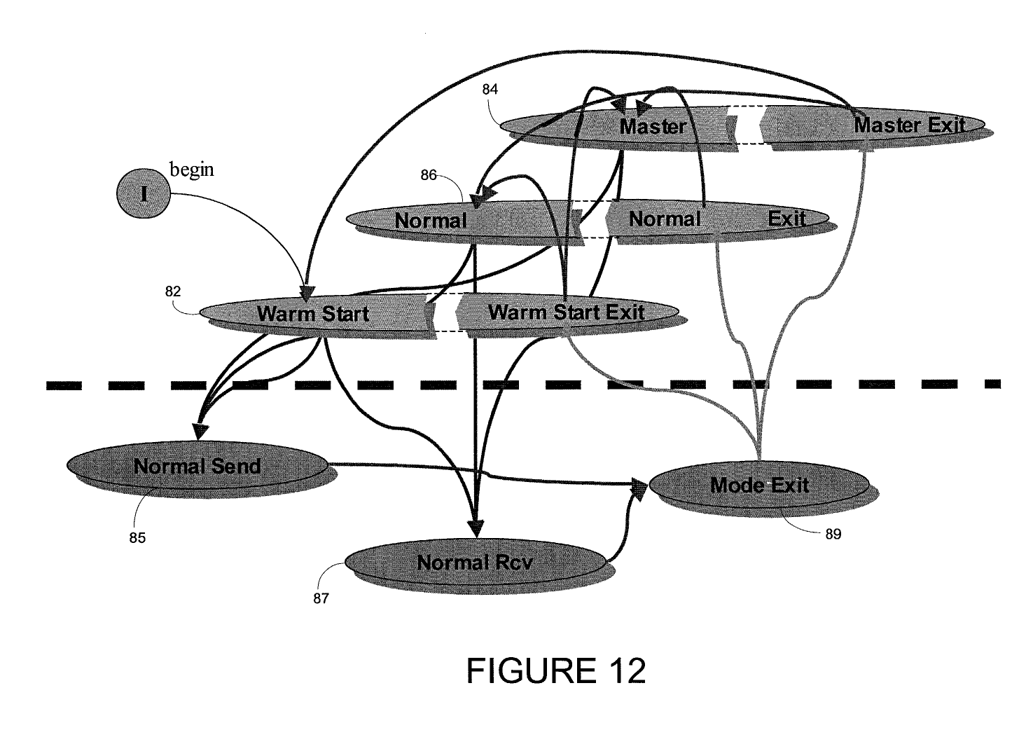

FIG. 12 shows some internal implementation details. Whether a station is configured in warm start 82, SBM master mode 84, or normal mode 86, or EBM master mode 85, its activities will consist of sending and receiving messages on the data bus. Some of these messages will be live data; some will be control messages like the BOS and EOS messages. All messages to and from the bus are dealt with in a consistent way by invoking low-level normal send 85 and receive 87 states. Upon completing these activities, an exit code is generated and returned to the exit side of the higher-level mechanisms for further processing.

It should be understood that the stations in the preferred embodiment are actually able to transmit and receive simultaneously. In other words, each of the stations can operate in a full duplex mode and the transmission of signals does not prevent the station from receiving signals.

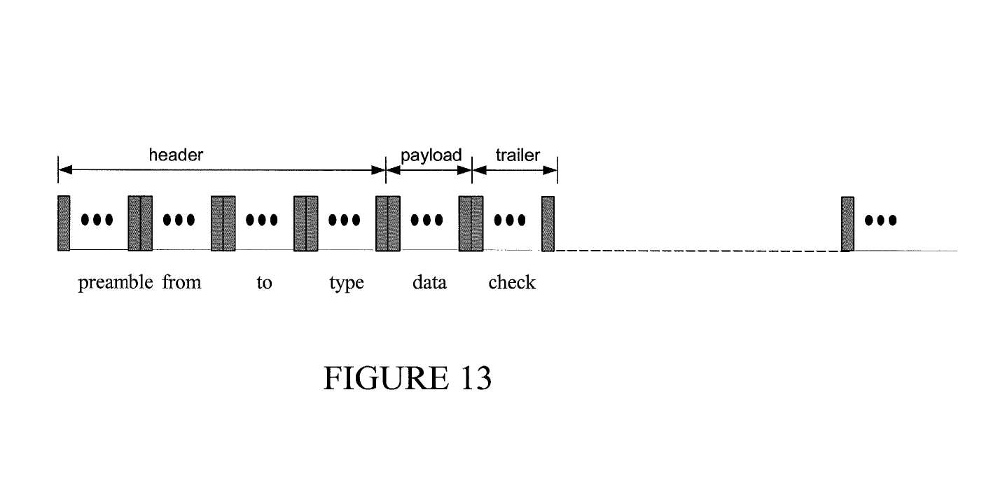

An example of the format of a message will now be described with reference to FIG. 13. Each message includes a header, data payload, and trailer. The header preferably includes a preamble that allows each station to detect the beginning of the message and also to provide synchronization of any internal clock. The header may also include addressing bits identifying where the message originated from and also the station to receive the message. In addition to identifying specific stations, the addressing bits may also designate groups of stations or the entire set of stations. These addressing bits enable multicasting and addressing of the information payload to stations and are separate from the multicasting and broadcasting ability of the networks to distribute all messages to all stations. The header also preferably includes bits that identify the type of message being sent. The systems and methods according to the invention may transmit any type of message, some examples of which include a table, message, a beginning of sequence message, end of sequence message, address, or combinations of the above message types. The data payload contains the actual data which, as discussed above, can be of variable length. This data may be either direct digital messages, audio or video, or digitized representations of normal analog signals, or video, or RF signals. Finally, the message preferably includes a trailer, which may contain some check bits for error correction and some bits to signal the end of a message.

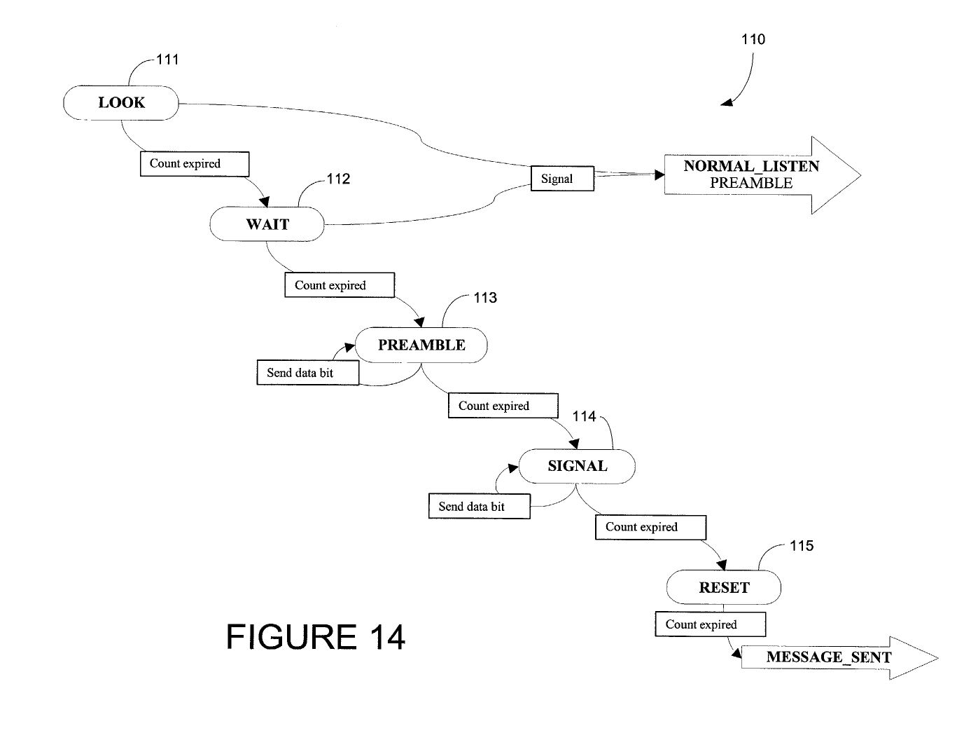

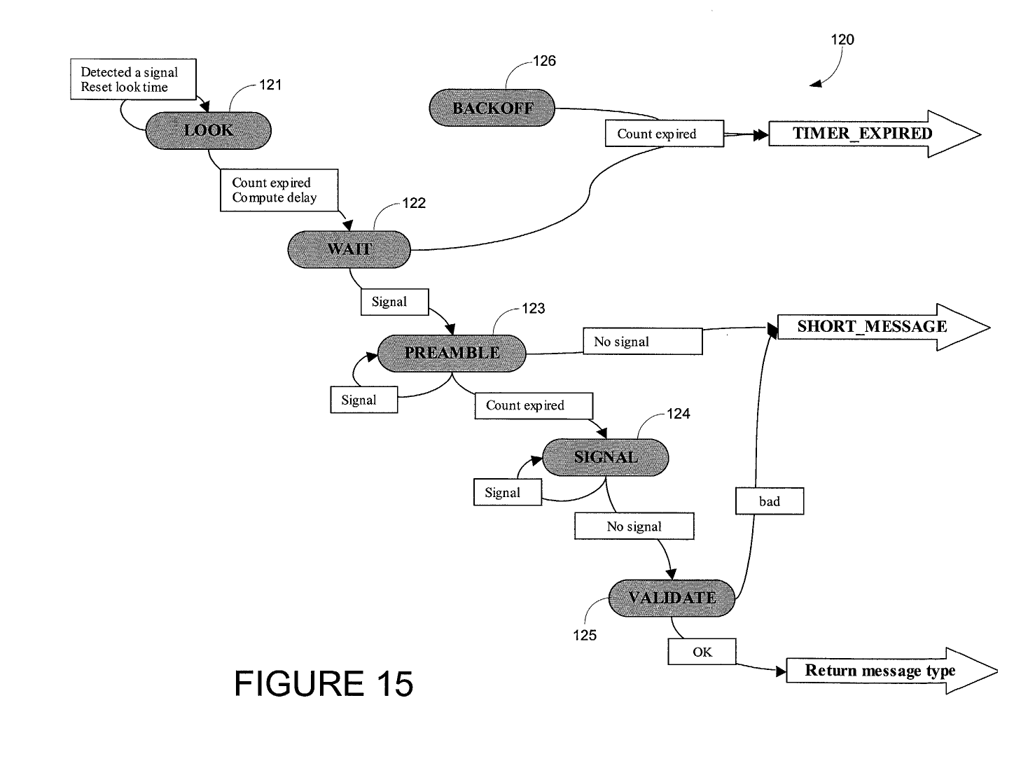

The normal send mode, described above with reference to FIG. 12 at 85, will now be described with more detail with reference to FIG. 14. A normal message send process 110 begins at 111 for the station looking for any communications on the bus. The station also goes through a wait phase at 112 looking for a signal. If a signal is detected either during the look phase at 111 or the wait phase at 112, the station enters the normal receive mode at 87 discussed below with reference to FIG. 15. If no signal is detected, then at 113 the station begins to transmit the preamble. After the preamble, the station then begins to transmit the signal itself and any data validation fields at 114. After the entire signal is transmitted, at 115 the station may reset itself for a specified number of cycles and determines that the message was successfully sent.

The normal receive mode described above with reference to FIG. 12 at 87 will now be described in more detail with reference to FIG. 15. A normal receive process 120 begins at 121 with the station looking for a signal at 121 and then waiting for a preamble at 122. If a count expires, then the station determines that the timer has expired and proceeds accordingly. If the station determines that there is no signal before each of these results occurs, the station then determines that a short message has been received. If a signal is detected at 124 and is validated at 125, the station determines that the message is good and returns the message type. The system response to abnormalities includes the ability to back off and wait 126. When the normal listen logic is put in this mode, nothing happens until the time randomly set for the backoff has expired. If the signal is received successfully, the station at 125 validates the message and returns the message type.

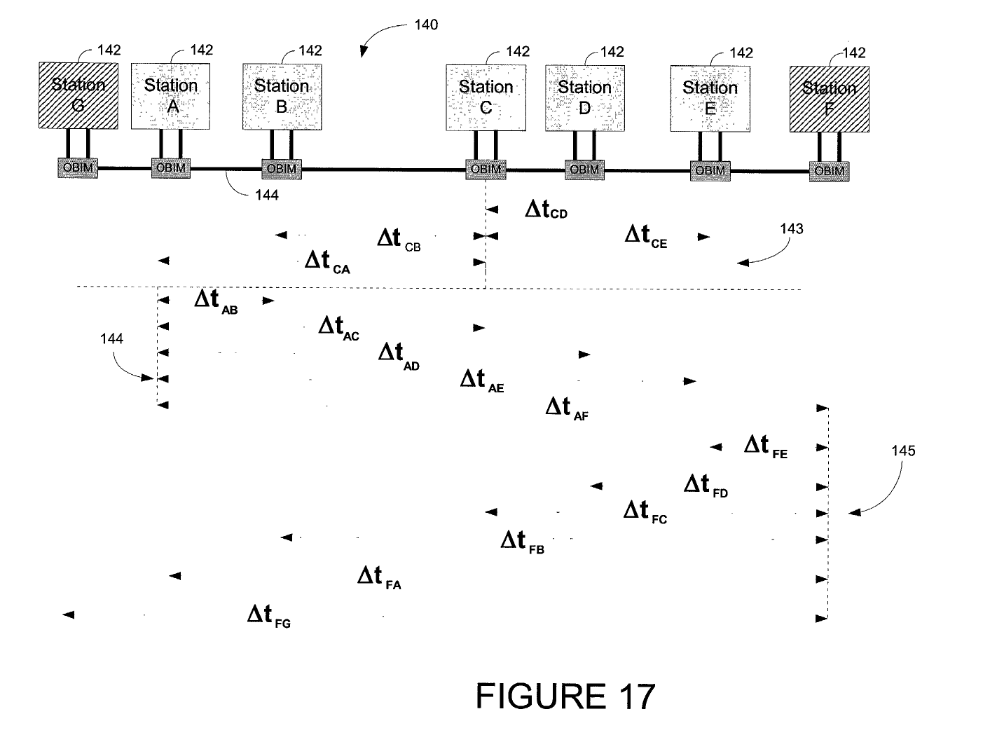

While new stations are joining this message cycle, a collision may occur between transmissions from two stations. These collisions primarily result from a new station outside the working diameter of the network physical layer entering the network and announcing their presence. The working diameter of a network physical layer includes the bus and all stations located between the SBM and EBM. Additional details of the working diameter and the manner in which stations are added or dropped will be become apparent from the description below associated with FIG. 17. During normal operation, the method of operation for the network is defined such that no collisions should occur. Thus, these collisions are the exception, rather than the norm. In contrast, as explained above, collisions are the norm with Ethernet and other protocols. The collisions that occur with methods according to the invention should therefore not be confused with collisions that occur with Ethernet and other such protocols. Because collisions do not occur during normal operation when stations are not added or dropped, the methods of the invention are well-suited for mission critical operations, both military and commercial operations. For non-mission critical operations, the methods of the invention are flexible and allow the dynamic addition and subtraction of stations.

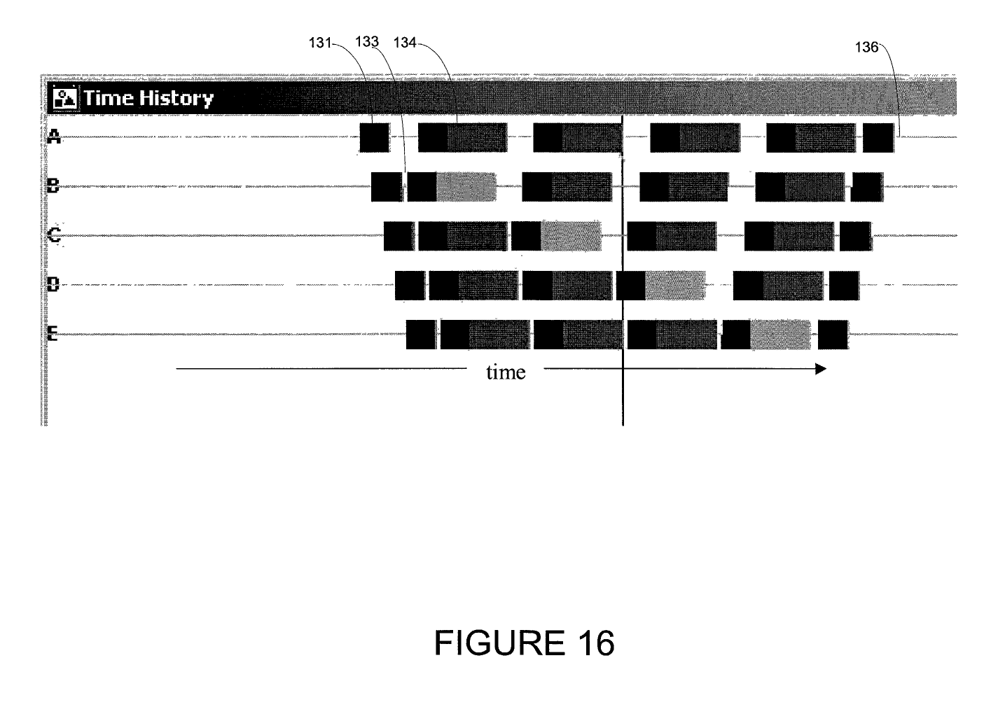

An example of a timing diagram for a typical exchange of messages will now be described with reference to FIG. 16. As discussed above with reference to FIG. 8, a message sequence begins at 131 with a BOS message which is preferably generated by the bus master. When the SBM sends the BOS message, it may include not only a new message map table if a station has joined or left the bus or physical layer but also its own data transmission. In this example, Station A has been appointed as the bus master and the bus also includes stations B, C, D, and E. As shown in this diagram, the BOS message and also the data message propagate through the network physical layer to the other stations. Next, at 133, the B station transmits a normal data message onto the bus which is shown to propagate back to the A station and also to stations C, D, and E. The normal data message is received at the A station at 134. In this example, the order of transmission is from A to B. C, D, and E. Thus, the timing diagram subsequently shows stations C, D, and E transmitting messages and placing them on the bus. As is apparent from the figure, the data messages from the different stations need not be of the same length, with the D station transmitting a relatively smaller data message than the other stations. After the EBM transmits its message, which is the E station, the E station then inserts the EOS message. After this EOS message reaches the SBM, the SBM waits a period of time called a clean-up pause at 136 before transmitting the next BOS message. One reason for inserting the clean-up pause at 136 is to allow new stations to inform the bus master that they are present so the bus master can act appropriately to add them onto the network.

As will be described in more detail below, when stations located along a bus between the SBM and EBM are added or dropped from the network, the network reacts smoothly to add or drop those stations. When a station is located on an opposite side of the SBM or EBM, the network still operates to add or drop that station, but transmissions from new stations joining the network physical layer may collide with another message on the bus. Unlike Ethernet and other protocols where collisions are normal, networks according to the invention do not normally experience collisions and, when they do, respond in a predefined deterministic manner to add the stations to the network.

III. Adding or Removing Stations

In the preferred operation of the invention, the SBM is at one end of the bus, the EBM is at the opposite end of the bus, and all of the other stations are between the two bus masters. The order of transmission authority is preferably from the SBM progressively down the bus to the EBM. Again, while the order in which the stations transmit is preferably in one direction, the stations preferably transmit information bi-directionally along the bus. The bus masters are preferably at either end of the bus in order to minimize delays between the transmission times of stations and thus to optimize use of the bus. While the bus masters are preferably at the ends of the bus, the invention may nonetheless still operate by having the bus masters located anywhere along the bus, such as in the middle.

The SBM is responsible for establishing the order of transmission for the stations based on the position of the stations along the bus. The position of the stations is deduced by transmission delays from when the SBM sends out a ping or query and the time the bus master receives a response from the stations. Preferably, the SBM creates a representation, such as a table showing the propagation delay associated with each station and reflecting the order of transmission. Depending upon the specific network, the SBM may also determine the wavelength or frequency of operation for each station as well as other parameters of operation. For instance, these other parameters include such things as a polarization of signals from the station, a time slot if the network is time division multiplexed, a number of information bits transmitted, the wavelength or frequency to transmit information, or the wavelength or frequency to receive information.

As mentioned above, the stations within a network may operate at different wavelengths. The assignment of wavelengths to stations may define distinct networks operating at distinct groups of wavelengths and/or these wavelengths may be assigned so that a single station transmits on one wavelength and receives information on a second wavelength. Further, while the preferred embodiments of the invention can accommodate wavelength division multiplexed signals, other embodiments of the invention in the RF domain may have different frequencies assigned to the stations.

Some examples will now be given on the generation of such tables and the assignment of a bus master in order to illustrate how stations can be both added and dropped from the network physical layer. First, with reference to FIG. 17, a network 140 includes stations 142 A, B, C, D, and E connected to a bus 144. In this example, all of the stations A to E are assigned the same wavelength, λ₁. The C station has been initially assigned the SBM and first pings each station and measures the associated delay time in receiving a response. The C station then creates a table, such as the one shown below in Table 1. Based on the delay times, the C station finds that the D station is closest followed by the E station, B station, and A station. The C station then assigns the A station to be the new SBM since it is farthest away from the C station. In this table, note that 0<Δt_{CD}<Δt_{CE}<ΔT_{CB}<Δt_{CA}.

TABLE 1

| Station | Δt | λ |
|---|---|---|
| C | 0 | λ₁ |
| D | 2Δt_{CD} | λ₁ |
| E | 2Δt_{CE} | λ₁ |
| B | 2Δt_{CB} | λ₁ |
| A | 2Δt_{CA} | λ₁ |

Next, the A station generates its own table of stations and associated delay times, such as the one shown below in Table 2. The order of transmission authority according to this table is the A station acting as the SBM followed by the B station, the C station, the D station, and then the E station as the EBM. During normal operation according to this arrangement, the A station will generate the BOS message followed by its data message, the B, C, D, and E stations will then follow with their messages, and then finally the E station will append the EOS message to signal the end of a message sequence. In this table, note that 0<Δt_{AB}<Δt_{AC}<ΔT_{AD}<Δt_{AE}.

TABLE 2

| Station | Δt | λ |
|---|---|---|
| A | 0 | λ₁ |
| B | 2Δt_{AB} | λ₁ |
| C | 2Δt_{AC} | λ₁ |
| D | 2Δt_{AD} | λ₁ |
| E | 2Δt_{AE} | λ₁ |

When new station wants to join the network physical layer, the new station interjects a message after the EOS message. Upon detection of one of these messages from a new station, the SBM reconstructs the table with the new station.

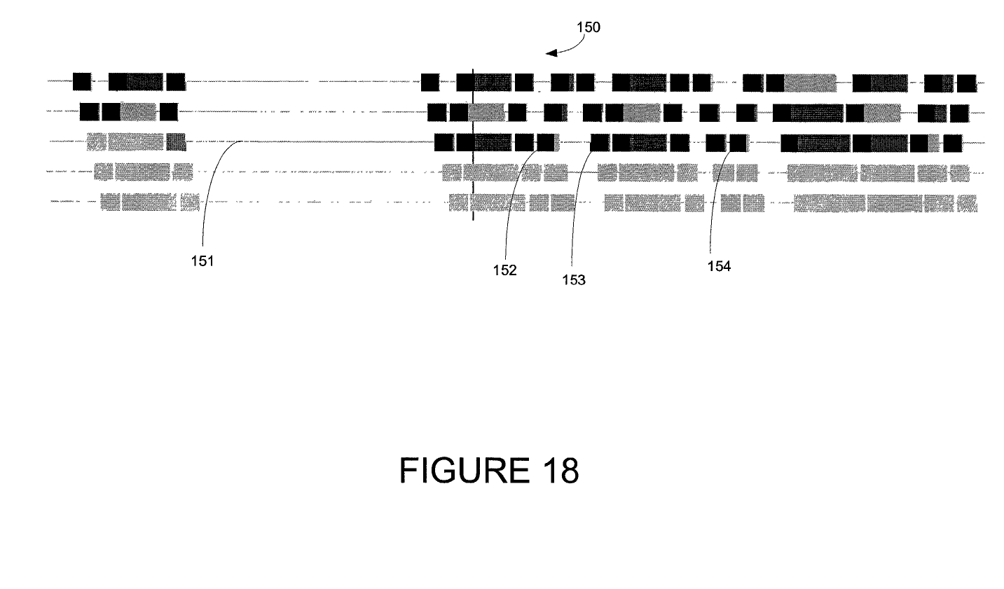

FIG. 18 provides an example of a method 150 by which a new station interjects and becomes added to a network physical layer. With reference to FIG. 18, at 151 a new station first waits and listens for the EOS message and, once found, sends a new station message onto the bus at 152. At 153, the new station then listens for a “who is there” message from the SBM which, when detected, responds by replying with a “here I am” message at 154. Referring again to the network shown in FIG. 17, when new stations F and G want to be added to the network 140 these stations 142 transmit their new station message over the bus 144 after the EOS message. Upon detecting new stations, the SBM, which in this example is the A station, recreates the table with these new stations. Table 3 shown below illustrates the addition of stations F and G to the table with their respective delay times. In this table, note that 0<Δt_{AG}<Δt_{AB}<ΔT_{AC}<Δt_{AD}<Δt_{AE}<Δt_{AF}.

TABLE 3

| Station | Δt | λ |
|---|---|---|
| A | 0 | λ₁ |
| G | 2Δt_{AG} | λ₁ |
| B | 2Δt_{AB} | λ₁ |
| C | 2Δt_{AC} | λ₁ |
| D | 2Δt_{AD} | λ₁ |
| E | 2Δt_{AE} | λ₁ |
| F | 2Δt_{AF} | λ₁ |

After recreating the table, the A station 142 then assigns the SBM to the farthest station, which is the F station 142. By transferring the starting bus station to the F station hi 142, the network 140 ensures that the bus masters are located at ends of the bus 144. If the A station 142 remained as the SBM, the order of transmission would be A, G, B, C, D, E, and F, which is not optimal since it introduces a large delay time between the time the G station transmits to the time when the B station can transmit. An example of a table generated by the F station 142 is shown below in Table 4. In Table 4, note that 0<Δt_{FE}<Δt_{FD}<Δt_{FC}<Δt_{FB}<Δt_{FA}<Δt_{FG}.

TABLE 4

| Station | Δt | λ |
|---|---|---|
| F | 0 | λ₁ |
| E | 2Δt_{FE} | λ₁ |
| D | 2Δt_{FD} | λ₁ |
| C | 2Δt_{FC} | λ₁ |
| B | 2Δt_{FB} | λ₁ |
| A | 2Δt_{FA} | λ₁ |
| G | 2Δt_{FG} | λ₁ |

The removal of a station from a network physical layer is triggered by the absence of any communication from that station. Each station transmits some type of message at its turn in the prescribed order, even if that station does not have any data to transmit. One of the responsibilities of all stations is to log messages received from each station on each cycle. Thus, the adjacent station can detect when the preceding station has not transmitted any type of message. When the preceding station is not the bus master, the next station times out waiting for data from its predecessor. It sends its own data and all stations consequently note the missing data record and all stations recreate the table of stations without the failed station. Alternative, the SBM may note the missing data record, recreate the table, and send the table to all stations. If the station that dropped out was the SBM, the first station in normal mode that is awaiting data will assume SBM responsibilities. After a delay period during which it does not receive any message after seeing the EOS message, the first station in normal mode adjacent to the EBM assigns itself the EBM mode, generates the EOS, and the data cycle proceeds.

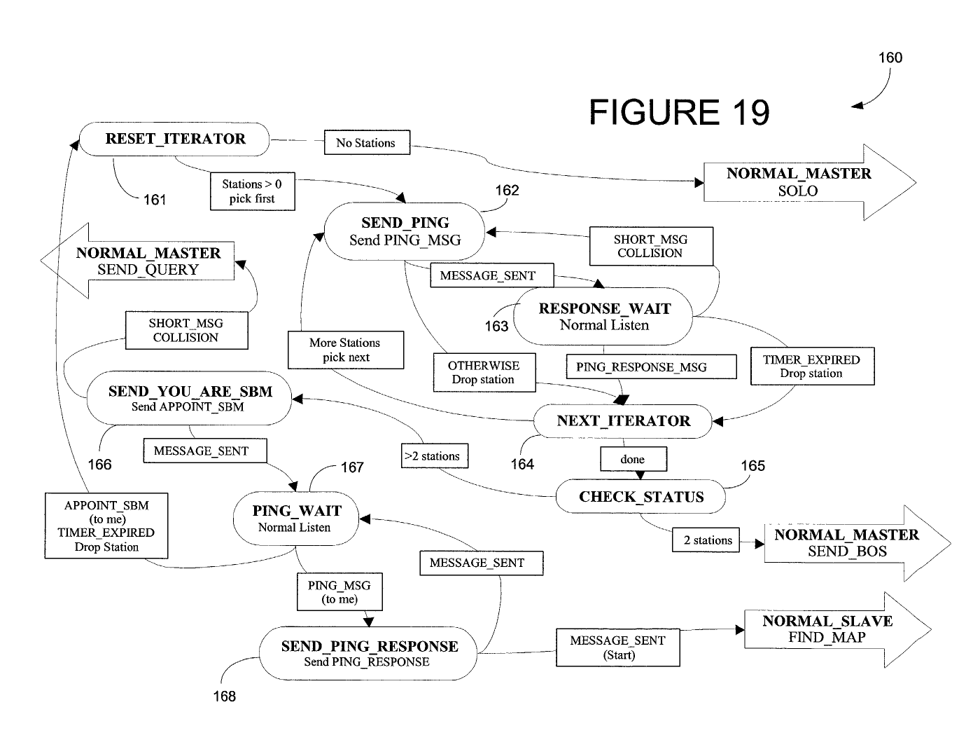

FIG. 19 illustrates the measurement mode process 160 that occurs when a new station joins the cycle. The process 160 begins at 161 where an SBM picks a first station on the network physical layer and sends a ping message at 162. The SBM then waits at 163 for a response. If a response is received from the station, or if a timer expires, the station then proceeds to send a ping message to the next station. After ping messages have been sent to all stations, the SBM then checks the status at 165. If there are only two stations, the SBM remains the SBM and sends the BOS message indicating the start of a message sequence. If, on the other hand there are more than two stations, the station is no longer the SBM, then at 166 the station informs the farthest stations that it is now the SBM. The station then waits to receive a ping from that bus master at 167 and responds at 168 so that the SBM can create its own table of stations. The station then acts in accordance starting the normal mode.

In addition to establishing the order in which stations transmit, the SBM also establishes the address of each station on the network. Preferably, a station's position in the transmission order is also that station's address. In other words, the first station which is the bus master will have an address of 01, the second station will have an address of 02, etc. The number of bits in the address can be adjusted to set the maximum number of stations on the bus.

As should be apparent from the description above, the network is self-organizing and does not need a network administrator to configure the network. Instead, during the start up, a bus master is appointed which determines which stations are on the network physical layer and transfers the bus master to the station at the end of the bus in order to improve performance of the network. The networks according to the invention are also self-reorganizing and diagnosing in that stations can be added or removed from the network physical layer. During either the addition or removal of a node, the network responds to ensure that the bus master remains at the end of the bus and optimizes the order of communications between the stations on the network physical layer. Another significant advantage of the invention is that the working diameter of a network physical layer or the bus length can be dynamically changed. With Ethernet and other protocols, a minimum message length is set based on an assumed length of the bus. Thus, a change in the bus length would necessitate a change in the minimum message length. In contrast, the networks according to the invention can have the bus length increased or reduced dynamically, without altering any minimum message length.

IV. Deterministic

An advantage of the invention is that networks operate in a highly deterministic manner. A typical message sequence is structured in that it includes the BOS message followed by messages from each of the stations in a predetermined order. At the end of each message sequence should be the EOS message. The state of each station on a network is also always defined leaving no uncertainty as to the state of the station or the state of the network. For instance, as described above with reference to FIGS. 12 and 13, stations send and listen for messages in predefined processes. Furthermore, stations are assigned as the bus master or as normal in highly structured ways described above with reference to FIGS. 11 and 12. Furthermore, even when a new station is added to a network physical layer or when the entire network begins operation, the stations go through a predefined warm start process 150 described above with reference to FIG. 18. When stations are added, removed, or when the network begins operation, the bus master enters the measurement mode described above with reference to FIG. 19. As evident from the state diagrams, the stations and the operation of the network overall is highly deterministic.

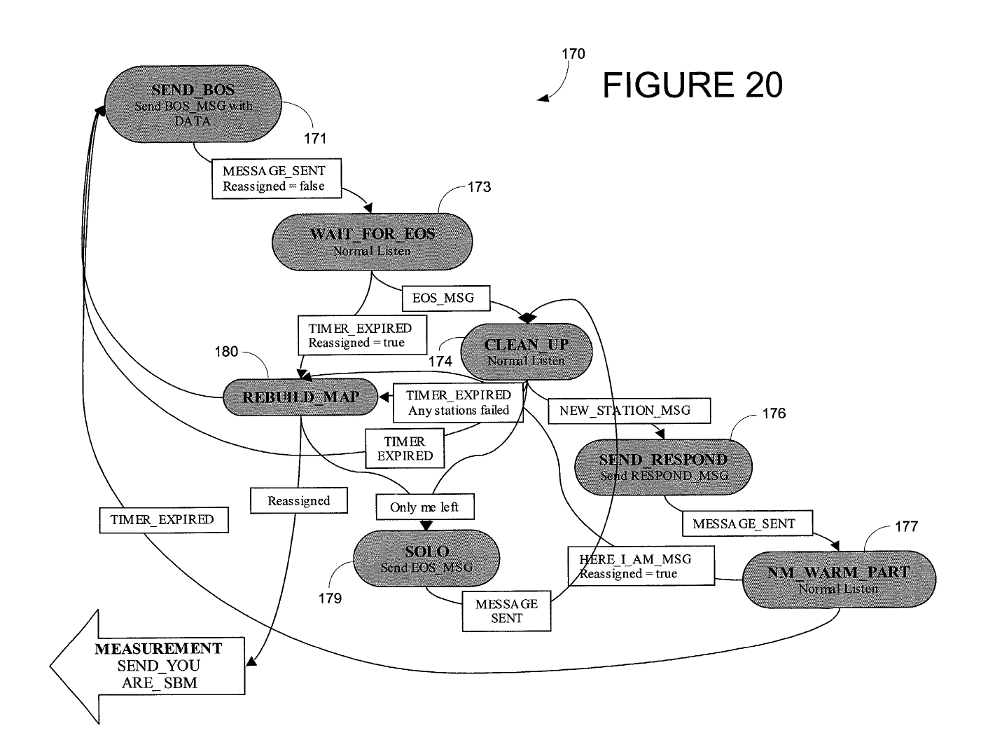

To further illustrate the deterministic manner of the stations and network, a description of a normal master mode for a station will now be described with reference to FIG. 20. A normal master mode process flow 170 begins at 171 with the master station sending a BOS message that may contain a new table and/or its outgoing data record. The bus master then waits for the EOS message at 173. If the EOS message is received and the bus master does not detect any signals in the subsequent delay period as determined at 174, then the bus master proceeds to send another BOS message at 171 along with any data message at 172.

If the EOS message is not received for a period of time, the bus master begins to rebuild the table or map of stations at 180 and then proceeds to the measurement mode described with reference to FIG. 19. If an incoming message is received rather than the EOS message, the bus master sends a query at 176 to allocate that station a unique ID. At 177, it waits for a response from the new station that will allow it to be positioned in the existing table. If the bus master then receives a response from the new station identifying it, the bus master proceeds to rebuild the map at 180. In rebuilding the map at 180, the bus master may discover that it is the only station on the bus and will proceed to a solo state at 179 followed by listening at 174 for new stations to join the bus.

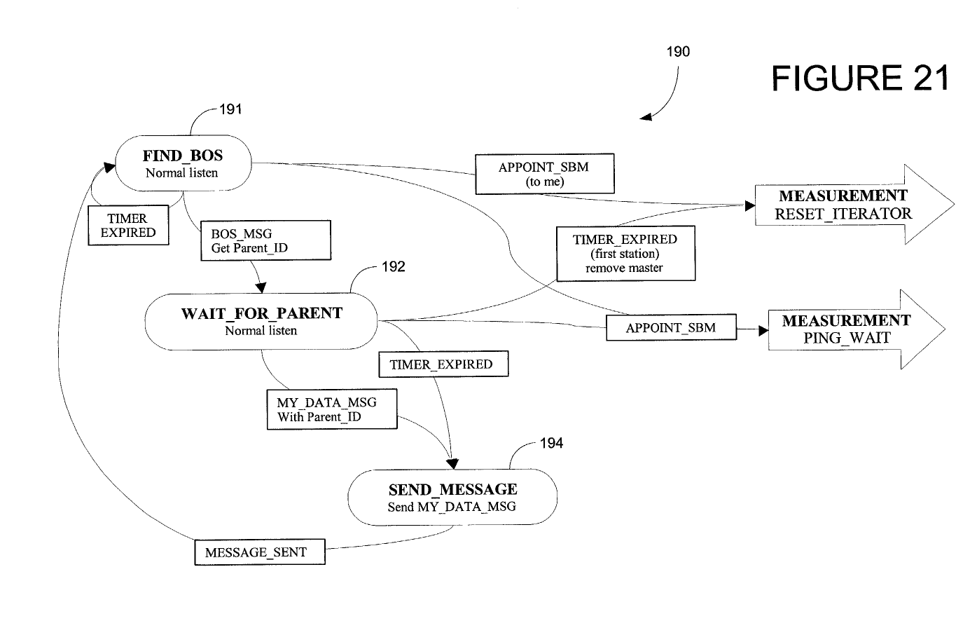

The normal mode for a station will now be described with reference to FIG. 21. The normal mode process 190 begins at 191 with the station finding the BOS message containing the table of stations on the network physical layer. If the SBM is appointed to that station, the station then proceeds to the measurement mode to rebuild the map. On the other hand, if the station finds the map, the station then waits at 192 for the station preceding it to transmit its message. Upon detecting the message from the preceding station, the station then sends its message at 194. If the station later sees the EOS message, the station can infer that its data was successfully sent and received by the other stations on the network and that the station need not retransmit the data at a later time. On the other hand, if the station sees a short message or a new station message, then the station assumes that a new station has arrived and will then wait for the map from the SBM. When waiting for the preceding station message at 192, the station will infer that the preceding station was dropped from the network physical layer if a period of time has elapsed with no message from the preceding station. Whether or not the header message was received, the station sends its own data message and checks to see that the message was sent at 194. If the station has no data to send, the station sends a small synch message to maintain the continuity. Exceptions will occur if the station in normal mode detects that a station has been appointed the SBM, or if the time expires while waiting for the preceding station, and that preceding station is the no SBM. If this station is appointed the SBM, it immediately begins polling the other stations to measure their distance. If another station is to become SBM, it switches to measurement mode to await that polling process before resuming normal operation. If the SBM appears to have failed, the current station appoints itself the bus master and may begin the polling process.

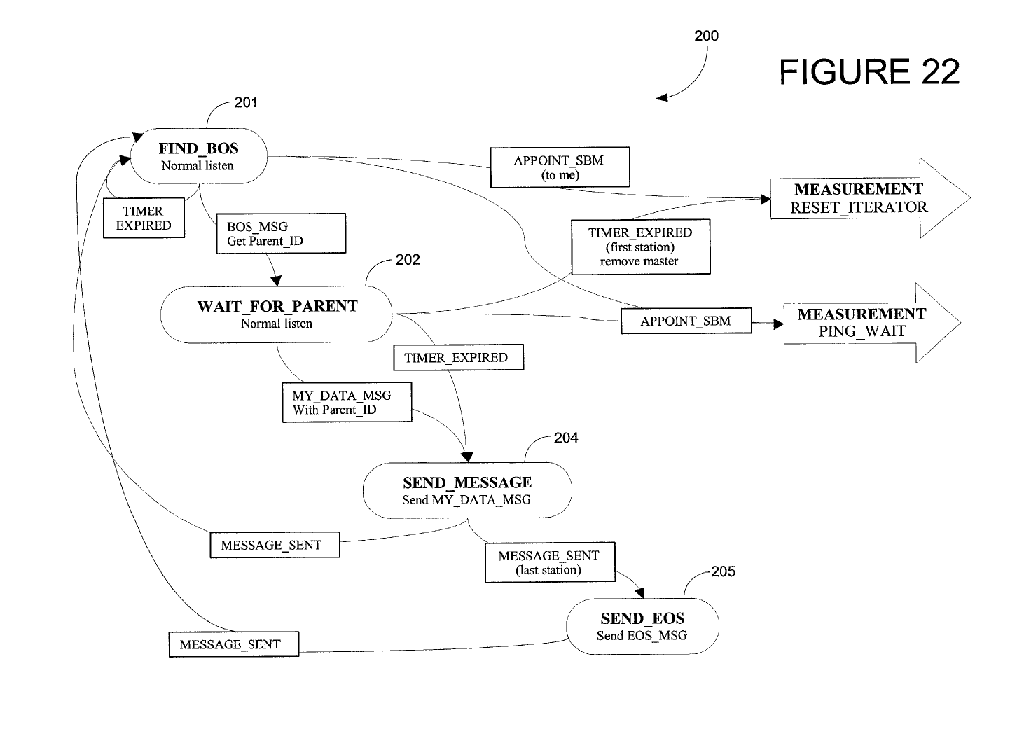

An ending bus master process 200 will now be described with reference to FIG. 22. The ending bus master process 200 begins at 201 with the EBM finding the BOS message containing the table of stations on the network physical layer. If the EBM is later appointed as the SBM, then that station proceeds to the measurement mode to rebuild the map. The EBM waits at 202 for its preceding station to transmit its message and then sends its own message at 204 followed by the EOS message at 205. If the EBM sees a short message or a new station message, then the EBM assumes that a new station has arrived and will then wait for the map from the SBM. When waiting for the preceding station message at 202, the EBM will infer that the preceding station was dropped from the network physical layer if a period of time has elapsed with no message from the preceding station. Whether or not the header message of the preceding station was received, the station sends its own data message and checks to see that the message was sent at 204. As with other stations, if the EBM has no data to send, the EBM sends a small synch message to maintain the transmission authority continuity.

V. Network Performance

In part because the network is so deterministic, the performance of the network can be easily ascertained and documented. By listening to the messages traveling on the bus, any of the stations can create an event log documenting the performance of the network. While not necessary, a network may have a dedicated station or other system for monitoring the communications on the network and recording the associated performance.

An example of an event log for the network 140 for transmission authority sequence 144 is shown below in Table 5. The event log should include a station identifier and may also include the information on the map or table of stations, such as the time delay and also wavelength of operation. The event log may capture every message transmitted on the network or, alternatively, may capture only a set of messages, such as error messages and the amount of data transmitted and received, so as to reduce the amount of storage needed to record the network performance. In the example given in Table 5, the event log tracks every message transmitted and received at a station. The stations in this example operate at more than one wavelength.

For instance, station A is the SBM for all stations operating on λ₂ and of its five (5) bytes transmitted all five (5) bytes were received by the intended stations. Station B is the SBM for all stations operating on λ₁, and none of the fifty-five (55) bytes that were transmitted was received by the intended stations. The event log shows than an error message of nine (9) is associated with that transmission, which could represent that the intended station to receive the message was dropped from the network physical layer. The entry for station C shows that the station is at a roundtrip time delay of 2Δt_{AC} from station A, operates on wavelength λ₂, in normal mode, and only twenty-five (25) bytes out of twenty-six (26) bytes transmitted were received by the intended station. This entry in the event log is coded with an error message five (5), which could represent a possible intermittent receiver module. The entry for station D shows that the station is at a round trip delay of 2Δt_{BD} from station B, operates on wavelength λ₁ in normal mode, and all two hundred seventeen (217) bytes transmitted were successfully received by the intended station. The entry for station E shows that the station is a round trip distance of 2Δt_{AE} from station A operates on λ₂, is the EBM for stations operating on λ₂, and all eight thousand one hundred ninety two (8,192) bytes transmitted were successfully received by the intended station. The sixth and final entry in the event log is for station F which operates on λ₁, is a round trip distance of 2Δt_{BF} from station A, is the EBM for stations operating on λ₂ and all four hundred twelve (412) bytes transmitted were received by the intended station. It should be understood that the table and the parameters monitored and logged are only examples and that additional fields may be added to the table.

TABLE 5

| | | | | Bytes | | |
|---|---|---|---|---|---|---|
| Station | Δt | λ | Error Msg. | Trans | Bytes Rec | Status |
| A | 0 | λ₂ | 0 | 5 | 5 | SBMλ₂ |
| B | 0 | λ₁ | 9 | 55 | | SBMλ₁ |
| C | 2Δt_{AC} | λ₂ | 5 | 26 | 25 | Nλ₂ |
| D | 2Δt_{BD} | λ₁ | 0 | 217 | 217 | Nλ₁ |
| E | 2Δt_{AE} | λ₂ | 0 | 8,192 | 4,096 | EBMλ₂ |
| F | 2Δt_{BF} | λ₁ | 0 | 412 | 412 | EBMλ₁ |

The foregoing description of the preferred embodiments of the invention has been presented only for the purpose of illustration and description and is not intended to be exhaustive or to limit the invention to the precise forms disclosed. Many modifications and variations are possible in light of the above teaching.

For example, while the invention has been described primarily with reference to operation on a single wavelength, it should be understood that the stations may communicate over the bus using two or more wavelengths. For instance, some of the messages may be transmitted at one wavelength while other messages are transmitted on a second wavelength. Further, a single fiber may support multiple networks operating independently of each other, each with its own starting bus master, group of stations in normal mode, and an ending bus master. Other variations using different wavelengths of light, polarization of signals, or allocation of time are encompassed by the invention.

The embodiments were chosen and described in order to explain the principles of the invention and their practical application so as to enable others skilled in the art to utilize the invention and various embodiments and with various modifications as are suited to the particular use contemplated.

What we claim:

1. A method of allocating a communication medium between a plurality of stations in a network, comprising:
dynamically assigning one of the stations as a starting bus master;
the starting bus master establishing an order in which the stations have access to the communication medium;
appointing an ending bus master to a last station in the order;
the starting bus master sending the order to all of the stations in the network;
the starting bus master initiating a message sequence with a beginning of sequence message;
the stations transmitting their messages after the beginning of sequence message according to the order; and
the ending bus master appending an end of sequence message which indicates an end of the message sequence.

2. The method as set forth in claim 1, wherein transmitting messages comprises monitoring at each station for the message from a preceding station in the order.

3. The method as set forth in claim 1, wherein transmitting messages comprises transmitting message of varying sizes.

4. The method as set forth in claim 1, wherein transmitting messages includes transmitting a synch message indicating that no data is being transmitted.

5. The method as set forth in claim 1, wherein assigning one of the stations as the starting bus master comprises assigning the bus master to a station at an end of the communication medium.

6. The method as set forth in claim 5, wherein assigning the starting bus master to the station at the end of the communication medium comprises sending queries to each station in the network and measuring delay time associated with responses from each station.

7. The method as set forth in claim 1, wherein assigning the starting bus master comprises assigning the first station as the bus master.

8. The method as set forth in claim 1, further comprising detecting a new station and adding the new station to the order.

9. The method as set forth in claim 8 wherein adding the new station to the order is performed by the starting bus master and the starting bus master sends the order having the new station to all stations.

10. The method as set forth in claim 8, wherein adding the new station to the order is performed by all stations.

11. The method as set forth in claim 8, wherein detecting the new station comprises detecting a new station message inserted by the new station after the end of sequence message.

12. The method as set forth in claim 8, further comprising assigning the starting bus master to the new station.

13. The method as set forth in claim 8, wherein detecting and adding the new station dynamically recomputes the length of the communication medium.

14. The method as set forth in claim 1, further comprising detecting a removal of one of the stations from the network and removing the one station from the order.

15. The method as set forth in claim 14, wherein removing the one station from the order is performed by the starting bus master and the starting bus master provides the order without the one station to all stations.

16. The method as set forth in claim 14, wherein removing the one station from the order is performed by all stations.

17. The method as set forth in claim 14, wherein detecting the removal of the one station comprises not detecting any message from the one station for a period of time.

18. The method as set forth in claim 14, wherein the one station removed from the network comprises the starting bus master and the method further comprises assigning the starting bus master to another one of the stations in the network.

19. The method as set forth in claim 14, wherein the one station removed from the network comprises the ending bus master and the method further comprises assigning the ending bus master to another one of the stations in the network.

20. The method as set forth in claim 14, wherein detecting the removal of the one station comprises reducing a length of the communication medium.

21. The method as set forth in claim 1, further comprising monitoring messages transmitted by the stations and generating an event log.

22. The method as set forth in claim 21, wherein generating the event log comprises identifying each station in the network and indicates an order of transmission authority.

23. The method as set forth in claim 21, wherein generating the event log comprises recording errors detected during operation of the network.

24. The method as set forth in claim 21, wherein generating the event log comprises tracking successful delivery of each message.

25. The method as set forth in claim 21, further comprising tracking a wavelength of operation for each station.

26. The method as set forth in claim 1, further comprising assigning a unique address to each station.

27. The method as set forth in claim 1, further comprising assigning stations different wavelengths to transmit messages.

28. The method as set forth in claim 1, further comprising assigning stations wavelengths to receive messages.

29. The method as set forth in claim 1, further comprising assigning stations frequencies to transmit messages.

30. The method as set forth in claim 1, further comprising assigning stations frequencies to receive messages.

31. The method as set forth in claim 1, further comprising detecting an absence of a message from one of the stations.
